(19) United States
(12) Patent Application Publication
(10) Pub. No.: US 2005/0007402 A1
(43) Pub. Date: Jan. 13, 2005

(54) Method and apparatus for firing ink in inkjet printer

(75) Inventor: Vladislav Terekhov, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/861,918

(22) Filed: Jun. 7, 2004

(30) Foreign Application Priority Data
Jun. 10, 2003 (KR) 2003-37264

(51) Int. Cl. B41J 29/38

(52) U.S. Cl. 347/9

(57) ABSTRACT

A method of firing, and an apparatus to fire, ink in an inkjet printer. The method includes receiving data to be printed, and firing the ink at different firing rates in sine wave shapes through multiple passes, according to the provided print data, wherein the data is printed by the ink fired in the sine wave shapes.

### CROSS-REFERENCE TO RELATED APPLICATIONS

This application claims the benefit of Korean Patent Application No. 2003-37264, filed on Jun. 10, 2003, at the Korean Intellectual Property Office, the disclosure of which is incorporated herein by reference.

### BACKGROUND OF THE INVENTION

1. Field of the Invention

The present invention relates to firing ink in an inkjet printer, and, more particularly, to a method of and an apparatus for firing ink in an inkjet printer, which performs a printing operation by firing ink from a print head through multiple passes.

2. Description of the Related Art

An inkjet printer performs a printing operation by firing ink through the nozzle of a print head. An ideal inkjet printer should be able to print optimal data, however, data with black banding, white banding, or lowered printing quality may be printed due to various reasons. The print head fires ink by moving as much as the width of a swath, and a black line or a white line may be generated on the printed object due to an error in the movement width of the print head. This phenomenon is referred to as black banding or white banding. In order to prevent the above problem from occurring, or to prevent printing quality being lowered, multi-pass printing operations are being utilized. FIGS. 1A and 1B illustrate the result of ink being fired through two passes. FIG. 1A illustrates the result of a first pass, in which 50% of the total amount of ink to be fired is fired, and FIG. 1B illustrates the result of a second pass, in which the remaining 50% of the total amount of ink to be fired is fired.

In spite of the printing process being performed through the above multi-pass process, problems such as ink bleeding between dots, twisting of the print head, unevenness of the nozzle arrangement or nozzle apertures, or deviation in ink dropping positions may still occur. Ink bleeding is the biggest contributor to lowered print quality. In particular, in the case in which the amount of ink used increases, or ink is fired again before ink fired from a previous pass is not completely dried, print quality is greatly lowered. FIG. 2A illustrates the result of ink not being fired to an empty space on a center portion, FIG. 2B illustrates the result of delayed ink firing on a center portion, and FIG. 2C illustrates the result of weakened ink firing on a center portion.

FIG. 3 illustrates the result of ink fired unevenly through a first pass when ink is fired through two passes. Ideally, when ink is fired properly, the printed object should result in a pattern as shown in FIG. 1A. However, due to delayed ink firing, the print quality is greatly lowered as shown in FIG. 3. Consequently, problems still exist in the conventional multi-pass printing process.

### SUMMARY OF THE INVENTION

The present invention provides a method of firing ink in an inkjet printer, which fires ink in a sine wave shape so that the rates at which ink is fired can be differentiated at every pass, when a printing process is performed by a multi-pass operation. The present invention provides an apparatus to fire ink of an inkjet printer performing the ink firing method described above.

Additional aspects and/or advantages of the invention will be set forth in part in the description which follows and, in part, will be obvious from the description, or may be learned by practice of the invention.

According to an aspect of the present invention, there is provided a method of firing ink in an inkjet printer, the method comprising receiving data to be printed, and firing the ink at different firing rates in sine wave shapes through multiple passes, according to the provided print data, wherein the data is printed by the ink fired in the sine wave shapes.

According to another aspect of the present invention, there is provided an apparatus to fire ink in an inkjet printer in which the ink is fired in multiple passes, the apparatus including a print head, and an ink firing controller to provide instructions to fire the ink so as to form sine wave shapes through each of the multiple passes, the instructions being provided as control signals to the print head, wherein the ink is fired in the sine wave shapes in response to the control signals.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B illustrate the result of ink fired through two passes;

FIGS. 2A-2C illustrate the results of a printing process with lowered print quality due to various reasons;

FIG. 3 illustrates the result of ink fired unevenly through a first pass when ink is fired through two passes;

FIG. 4 is a flowchart of a method of firing ink in an inkjet printer according to an embodiment of the present invention;

FIG. 5 is a flowchart illustrating an embodiment of operation 12 of FIG. 4;

FIGS. 6A and 6B illustrate the result of ink fired as sine wave shapes in a longitudinal direction according to the embodiment shown in FIG. 5;

FIGS. 7A and 7B illustrate the result of ink fired as sine wave shapes in a transverse direction according to the embodiment shown in FIG. 5;

FIG. 8 is a flowchart describing another embodiment of operation 12 shown in FIG. 4;

FIGS. 9A-9C illustrate the result of ink fired as sine wave shapes in a longitudinal direction according to the embodiment of the present invention shown in FIG. 8;

FIGS. 10A-10C illustrate the result of ink fired as sine wave shapes in a transverse direction according to the embodiment of the present invention shown in FIG. 8;

FIG. 11 illustrates the result of ink fired unevenly in operation 50 of FIG. 8;

FIG. 12 is a flowchart illustrating still another embodiment of operation 12 of FIG. 4;

FIGS. 13A-13D illustrate the result of ink fired as sine wave shapes in a longitudinal direction according to the embodiment shown in FIG. 12;

FIGS. 14A-14D illustrate the result of ink fired as sine wave shapes in a transverse direction according to the embodiment shown in FIG. 12; and

FIG. 15 is a block diagram of a portion of an apparatus to fire ink in an inkjet printer according to an embodiment of the present invention.

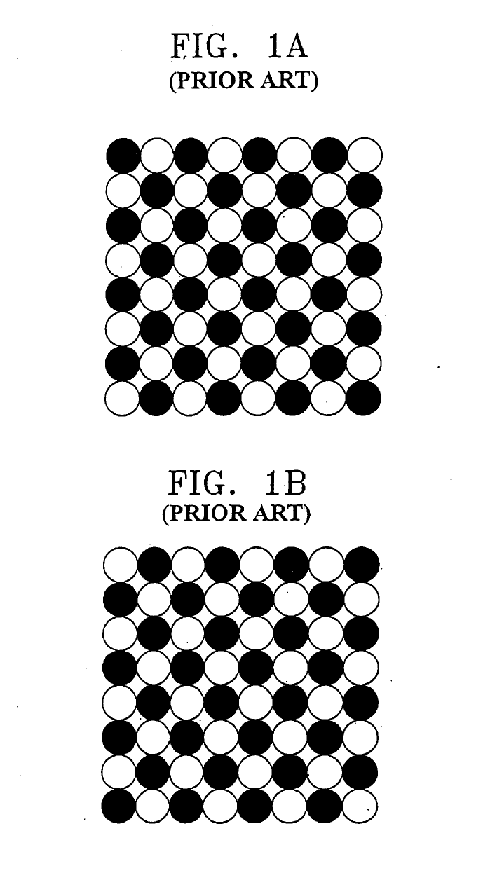

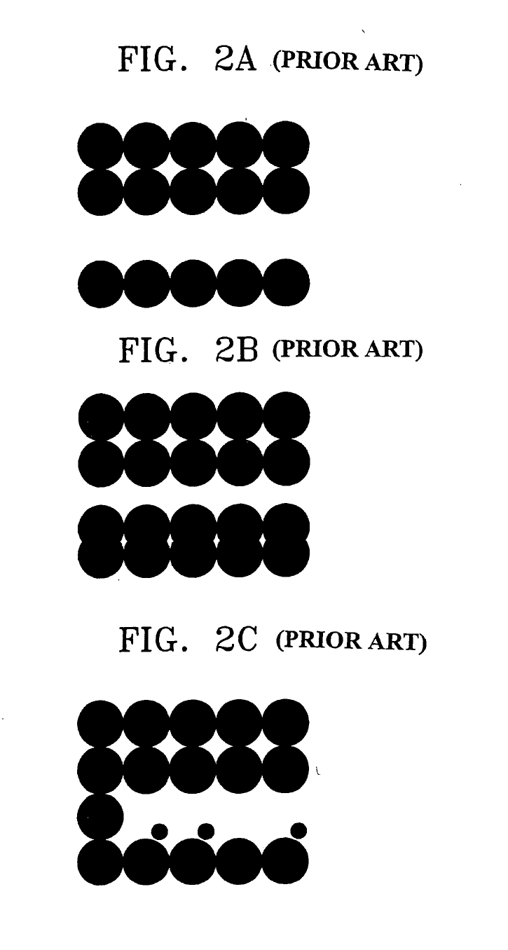

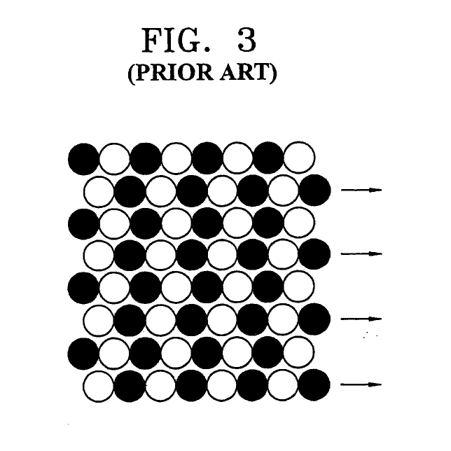

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

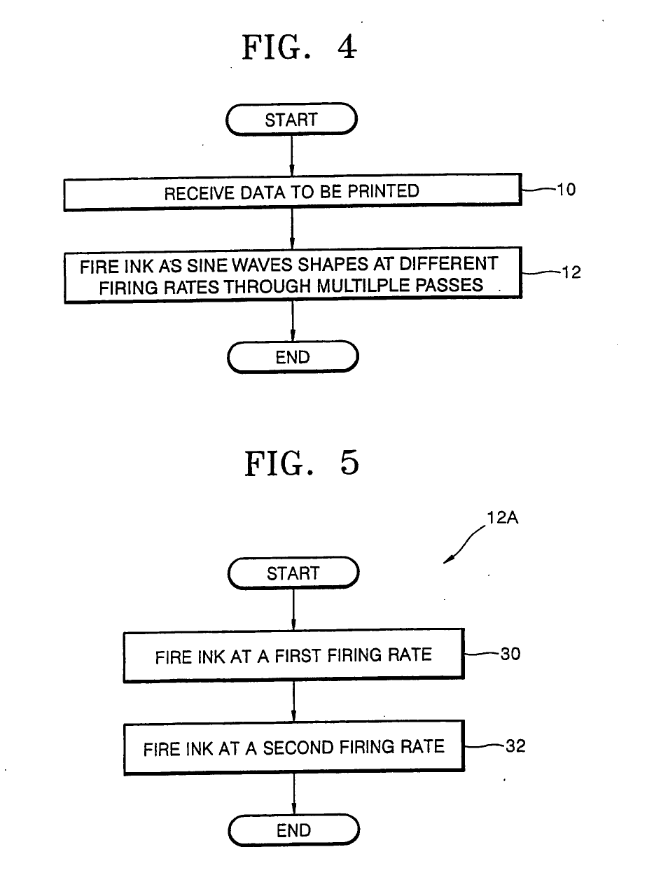

FIG. 4 is a flowchart describing the method of firing ink in an inkjet printer according to an embodiment of the present invention, and includes an operation in which ink is fired in a sine wave shape, or other waveform shape, at a firing rate during each pass of a print head.

In operation 10, data to be printed is provided. The data may be provided from a computer, which is connected to the inkjet printer, or from a host connected through a network. The data may be mono-color printing data or multi-color printing data.

After performing operation 10, ink is fired as sine wave shapes at different firing rates through each pass of multiple passes in operation 12. The firing rate means a rate of the number of dots through which the ink is fired at each pass. The sine wave shapes may be formed in a transverse direction or in a longitudinal direction.

FIG. 5 is a flowchart of an embodiment 12A of operation 12 shown in FIG. 4, and includes firing ink at a first firing rate, operation 30, and firing ink at a second firing rate, operation 32, when ink is fired through two passes. The first firing rate and the second firing rate are the percentages of dots, through which the ink is fired, of the passes. The first and the second firing rates are different from each other.

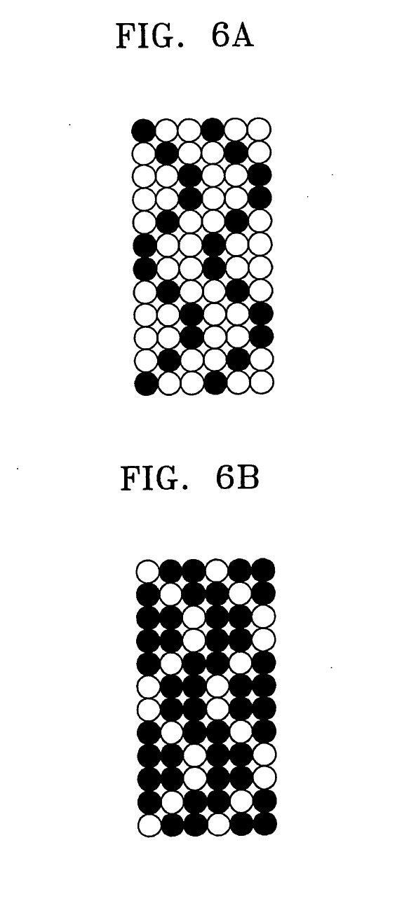

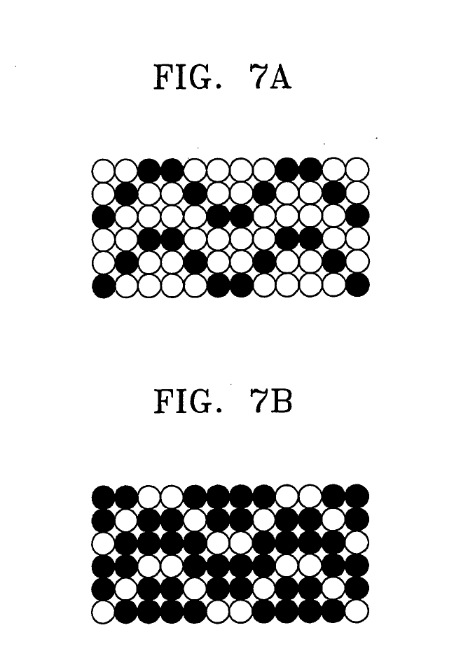

FIGS. 6A and 6B illustrate the result of ink fired as sine wave shapes in a longitudinal direction in the embodiment 12A shown in FIG. 5, and FIGS. 7A and 7B illustrate the result of ink fired as sine wave shapes in a transverse direction in the embodiment 12A shown in FIG. 5.

Ink is fired at the first firing rate during the first pass, in operation 30. For example, FIG. 6A and FIG. 7A illustrate results of ink fired during a first pass at the first firing rate, which corresponds to 33% of the dots to be fired, to form the longitudinal sine wave shapes or the transverse sine wave shapes.

After performing operation 30, ink is fired at a second firing rate during a second pass in operation 32. For example, FIG. 6B and FIG. 7B illustrate results of ink fired during a second pass at the send firing rate, which corresponds to 67% of the dots to be fired, to form the sine wave shapes in the longitudinal direction or in the transverse direction.

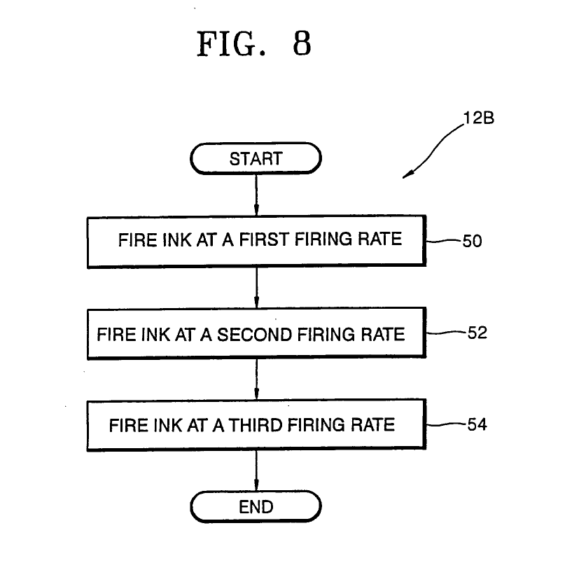

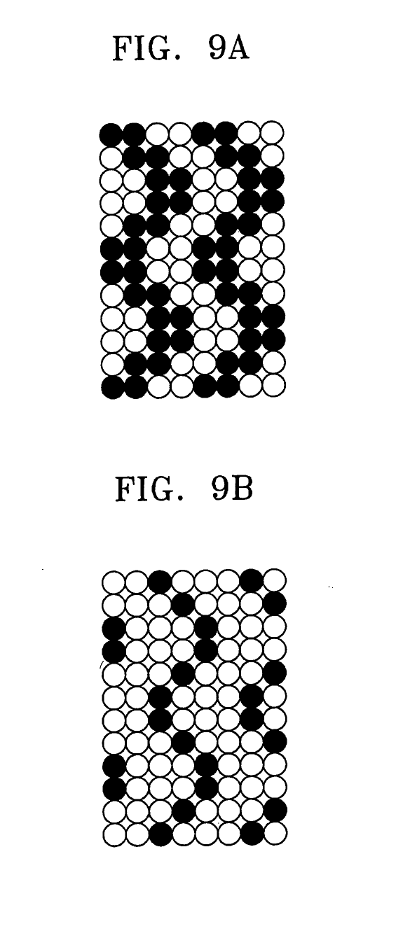

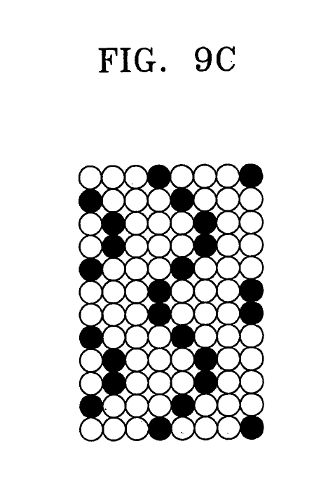

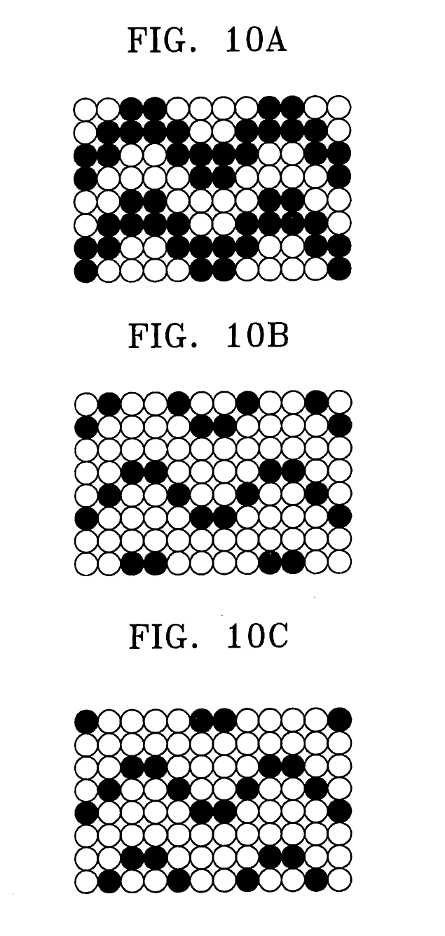

FIG. 8 is a flowchart of another embodiment 12B of the operation 12 shown in FIG. 4, which includes firing ink at a first firing rate, operation 50, a second firing rate, operation 52, and a third firing rate, operation 54, when ink is fired through three passes. The first firing rate, the second firing rate, and the third firing rate are the percentages of dots through which the ink is fired in the three passes. One or more rates of the first, second, and third firing rates is different from the others. FIGS. 9A-9C illustrate the result of ink fired as sine wave shapes in the longitudinal direction in the embodiment 12B shown in FIG. 8, and FIGS. 10A-10C illustrate the result of ink fired as sine wave shapes in the transverse direction in the embodiment 12B shown in FIG. 8.

In operation 50, ink is fired at the first firing rate during a first pass. For example, FIG. 9A and FIG. 10A illustrate results of ink fired at the first firing rate, which is 50% in this embodiment, through the first pass, to form the sine wave shape in the longitudinal direction or in the transverse direction.

After performing operation 50, in operation 52, ink is fired at the second firing rate during a second pass. For example, FIG. 9B and FIG. 10B illustrate results of ink fired at the second firing rate, which is 25% in this embodiment, through the second pass, to form the sine wave shape in the longitudinal direction or in the transverse direction.

After performing operation 52, in operation 54, ink is fired at the third firing rate during a third pass. For example, FIG. 9C and FIG. 10C illustrate results of ink fired at the third firing rate, which is 25% in this embodiment, through the third pass, to form the sine wave shape in the longitudinal direction or in the transverse direction.

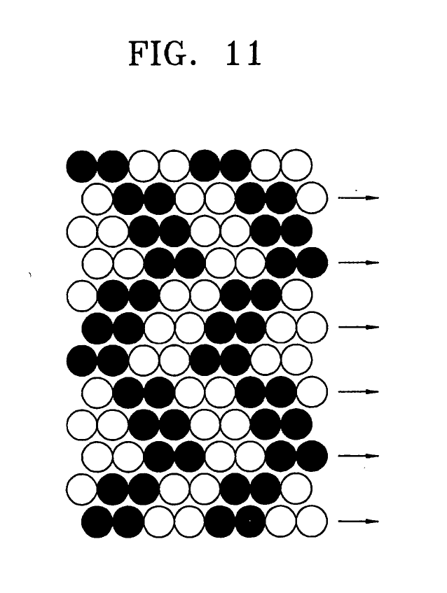

FIG. 11 illustrates the result of ink fired unevenly in operation 50 shown in FIG. 8. Even if ink is fired unevenly as shown in FIG. 11, ink is fired in sine wave shapes with different numbers of dots to maintain gaps between the dots, thus preventing ink from bleeding or lowering print quality. Contrarily, when ink is fired unevenly according to the conventional art shown in FIG. 3, the ink may bleed or print quality may be lowered.

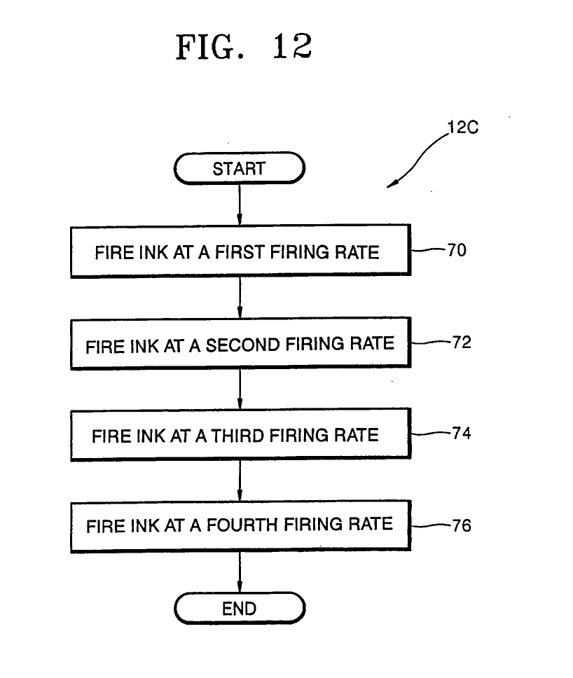

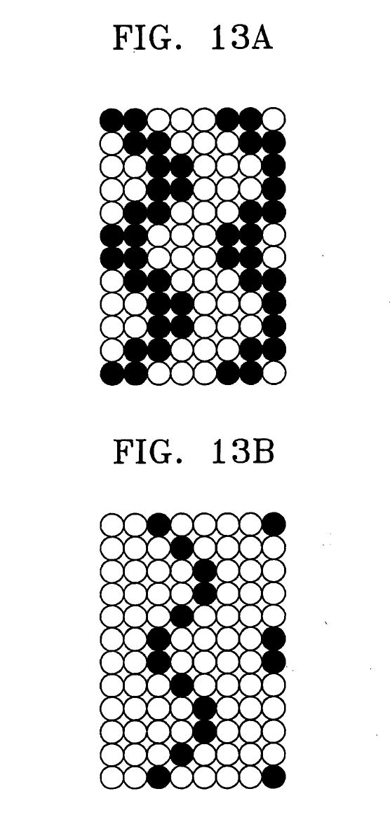

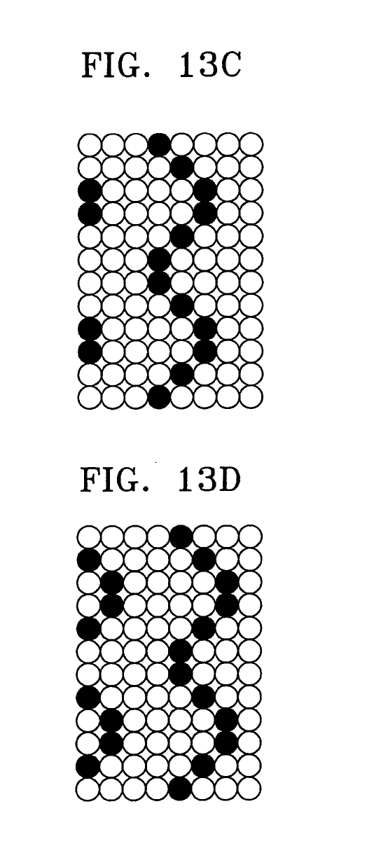

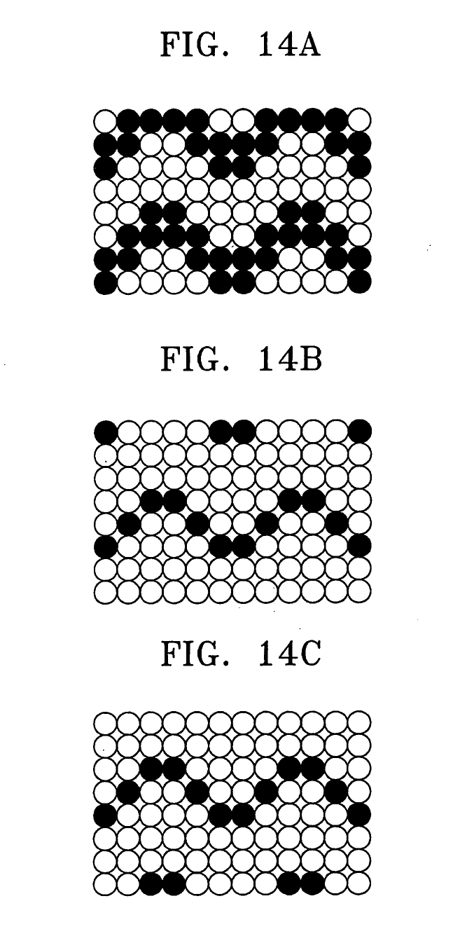

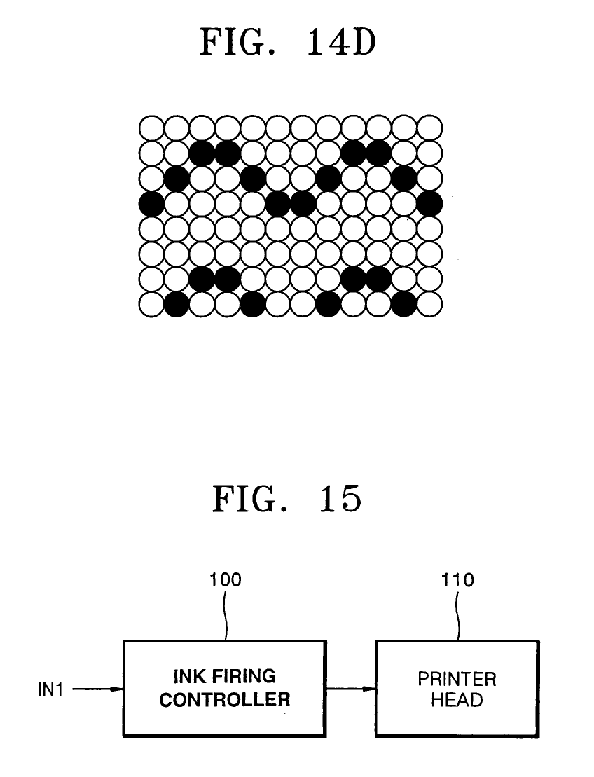

FIG. 12 is a flowchart of still another embodiment 12C of operation 12 shown in FIG. 4, and includes firing ink at a first firing rate, operation 70, firing ink at a second firing rate, operation 72, firing ink at a third firing rate, operation 74, and firing ink at a fourth firing rate, operation 76, when the ink is fired through four passes. The first, second, third, and fourth firing rates are the rates of the number of dots, through which the ink is fired in the four passes. One or more of the first, second, third, and fourth firing rates is different from the others. FIGS. 13A-13D illustrate the result of ink fired as sine wave shapes in the longitudinal direction in the embodiment 12C shown in FIG. 12, and FIGS. 14A-14D illustrate the result of ink fired as sine wave shapes in the transverse direction in the embodiment 12C shown in FIG. 12.

In operation 70, ink is fired at the first firing rate during a first pass. For example, FIG. 13A and FIG. 14A illustrate results of ink fired at the first firing rate, which is 40% in this embodiment, during the first pass, to form the sine wave shapes in the longitudinal direction or the transverse direction.

After performing operation 70, in operation 72, ink is fired at the second firing rate during a second pass. For example, FIG. 13B and FIG. 14B illustrate results of ink fired at the second firing rate, which is 20% in this embodiment, during the second pass, to form the sine wave shape in the longitudinal direction or in the transverse direction.

After performing operation 72, in operation 74, ink is fired at the third firing rate. For example, FIG. 13C and FIG. 14C illustrate results of ink fired at the third firing rate, which is 20% in this embodiment, during the third pass, to form the sine wave shape in the longitudinal direction and in the transverse direction.

After performing operation 74, in operation 76, ink is fired at the fourth firing rate during the fourth pass. For example, FIG. 13D and FIG. 14D illustrate results of ink fired corresponding to the fourth firing rate, which is 20% in this embodiment, during the fourth pass, to form the sine wave shape in the longitudinal direction and in the transverse direction.

Hereinafter, an apparatus to fire ink in an inkjet printer according to an embodiment of the present invention will be described with reference to the accompanying drawings.

FIG. 15 is a block diagram of an apparatus for firing ink in the inkjet printer, and includes an ink firing controller 100 and a print head 110.

The ink firing controller 100 receives data to be printed through an input port IN1, formulates instructions to fire ink as sine wave shapes in passes with different rates from each other, and outputs the resulting instructions to the print head 110 as a control signal. The ink firing controller 100 provides instructions for multiple passes to fire ink. In addition, ink is fired so as to form the sine wave shapes in the longitudinal direction or in the transverse direction.

When ink is fired through two passes at a first rate and a second rate, which are different from each other, the ink firing controller 100 provides instructions for the first pass to inject ink at the first rate, and instructions for the second pass to inject ink at the second rate. When ink is fired through two passes, the ink firing controller 100 controls the print head 110 so that sine wave shapes in the longitudinal direction illustrated in FIGS. 6A and 6B, or in the transverse direction illustrated in FIGS. 7A and 7B, can be represented.

When ink is fired through three passes having different firing rates, that is, a first firing rate, a second firing rate, and a third firing rate, one of which is different from the others, the ink firing controller 100 provides instructions for the first pass to fire ink at the first firing rate, instructions for the second pass to fire ink at the second firing rate, and instructions for the third pass to fire ink at the third firing rate. When ink is fired through three passes, the ink firing controller 100 controls the print head 110 so that ink is fired as sine wave shapes in the longitudinal direction illustrated in FIGS. 9A-9C, or in the transverse direction illustrated in FIGS. 10A-10C.

When ink is fired through four passes at a first firing rate, a second firing rate, a third firing rate, and a fourth firing rate, one or more of which is different from the others, the ink firing controller 100 provides instructions for the first pass to fire ink at the first firing rate, instructions for the second pass to fire ink at the second firing rate, instructions for the third pass to fire ink at the third firing rate, and instructions for the fourth pass to fire ink at the fourth firing rate. When ink is fired through four passes, the ink firing controller 100 controls the print head 110 so that ink can be fired as sinusoidal waves in the longitudinal direction illustrated in FIGS. 13A-13D, or in the transverse direction illustrated in FIGS. 14A-14D.

The print head 110 fires ink through the nozzle to print data according to the control signal received from the ink firing controller 100. The print head 110 may be operated in the same way as the conventional art.

According to the present invention, ink is fired to form sine wave shapes when ink is fired through a multi-pass print operation, thus preventing print quality from being lowered due to problems such as ink bleeding, twisting of the print head, unevenness of nozzle arrangement or nozzle apertures, and deviation of ink dropping positions.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of firing ink in an inkjet printer, the method comprising:
receiving data to be printed; and
firing the ink at different firing rates in sine wave shapes through multiple passes, according to the provided print data,
wherein the data is printed by the ink fired in the sine wave shapes.

2. The method of claim 1, wherein the sine wave shapes are longitudinal sine wave shapes or transverse sine wave shapes.

3. The method of claim 2, wherein the firing the ink at different firing rates in sine wave shapes through multiple passes comprises:
firing the ink at a first firing rate during a first pass; and
firing the ink at a second firing rate during a second pass,
wherein the first firing rate is different from the second firing rate.

4. The method of claim 2, wherein the firing the ink at different firing rates in sine wave shapes through multiple passes comprises:
firing the ink at a first firing rate during a first pass;
firing the ink at a second firing rate during a second pass; and
firing the ink at a third firing rate during a third pass,
wherein at least one of the firing rates is different from at least one of a remainder of the firing rates.

5. The method of claim 2, wherein the firing the ink at different firing rates in sine wave shapes through multiple passes comprises:
firing the ink at a first firing rate during a first pass;
firing the ink at a second firing rate during a second pass;
firing the ink at a third firing rate during a third pass; and
firing the ink at a fourth firing rate during a fourth pass,
wherein at least one of the firing rates is different from at least one of a remainder of the firing rates.

6. The method of claim 1, wherein the data is provided from a computer which is connected to the inkjet printer.

7. The method of claim 1 wherein the data is provided from a host connected to the inkjet printer through a network.

8. The method of claim 1, wherein the data is mono-color printing data or multi-color printing data.

9. An apparatus to fire ink in an inkjet printer in which the ink is fired in multiple passes, the apparatus comprising:
a print head; and
an ink firing controller to provide instructions to fire the ink so as to form sine wave shapes through each of the multiple passes, the instructions being provided as control signals to the print head;
wherein the ink is fired in the sine wave shapes in response to the control signals.

10. The apparatus of claim 9, wherein the ink firing controller controls the ink to be fired as a sine wave shape in a longitudinal direction or a sine wave shape in a transverse direction.

11. The apparatus of claim 10, wherein the ink firing controller provides instructions to fire the ink during a first pass at a first firing rate, and to fire the ink during a second pass at a second firing rate, wherein the first firing rate is different from the second firing rate.

12. The apparatus of claim 10, wherein the ink firing controller provides instructions to fire the ink during a first pass at a first firing rate, to fire the ink during a second pass at a second firing rate, and to fire the ink during a third pass at a third firing rate, wherein at least one of the firing rates is different from at least one of a remainder of the firing rates.

13. The apparatus of claim 10, wherein the ink firing controller provides instructions to fire the ink during a first pass at a first firing rate, to fire ink during a second pass at a second firing rate, to fire ink during a third pass at a third firing rate, and to fire ink during a fourth pass at a fourth firing rate, wherein at least one of the firing rates is different from at least one of a remainder of the firing rates.

14. A method of firing ink in an inkjet printer, the method comprising firing the ink in a waveform shape onto a printing medium.

15. The method of claim 14, wherein the waveform shape is a sine wave shape.

16. The method of claim 14, wherein the ink is fired in multiple passes along a printing area of the printing medium.

17. An apparatus to fire ink in an inkjet printer, the apparatus comprising:
an ink firing controller to fire the ink in waveform shapes onto a printing medium;
wherein the ink is fired in the waveform shapes in multiple passes along the printing medium.

18. The apparatus of claim 17, wherein the waveform shapes are sine wave shapes.
